(19) United States
(12) Patent Application Publication
(10) Pub. No.: US 2018/0058073 A1
(43) Pub. Date: Mar. 1, 2018

(54) BALUSTRADE ARRANGEMENT

(71) Applicant: Lance Malcolm VATER, St. Georges, South Australia (AU)

(72) Inventor: Lance Malcolm VATER, St. Georges, South Australia (AU)

(21) Appl. No.: 15/555,990

(22) PCT Filed: Mar. 4, 2016
(86) PCT No.: PCT/AU2016/000065

§ 371 Date: Sep. 6, 2017

(30) Foreign Application Priority Data
Mar. 6, 2015 (AU) 2015201165

(51) Int. Cl. E04F 11/18; F16B 7/04

(52) U.S. Cl. CPC E04F 11/1834; F16B 35/005; E04F 2011/1821; F16B 7/0486

(57) ABSTRACT

A balustrade arrangement including a T-clamp of metal formed into a tubular shape member with a pair of open ends at a top and bottom of a comparable dimension to allow a hand rail to be recessed therein. The tubular shaped member has opposing peripheral side edges terminating in a pair of separated tab extensions substantially orthogonally orientated externally out from respective side edges. A cup adapted to enclose an upper end of an upright support post includes a tab protruding from the cup and adapted to nest between the pair of separated tab extensions of the tubular shaped member so that respective apertures defined within the pair of tab extensions and the tab protruding from the end cup are aligned so as to allow a bolt to pass there through. The fastening of the bolt brings together the rail and the upright support post.

### FIELD OF THE INVENTION

This invention relates generally to a new and improved balustrade arrangement and more particularly to unique inter-connecting and support fittings to conveniently and aesthetically inter-connect a cross member hand rail and/or kick rail to the appropriate support posts of the balustrade arrangement.

### BACKGROUND ART DISCUSSION

For stairways, staircases, balconies, open platforms, decks and the like, there is the requirement to include railings at the periphery of these structures to prevent people falling off and so forth.

Generally a balustrade arrangement has the cross rail which can include a hand rail as well as a base kick rail, if required, connected to a series of intermediate vertical support posts.

While there are various types of connectors available in the marketplace which are adapted to connect the cross (hand) rail and/or kick rail to the upright support posts, none have gained widespread acceptance because of their difficulty of use, inability for quick installation, lack of aesthetic appeal and also, importantly, their costs and difficulties in manufacture.

It would be particularly advantageous and an object of this invention to be able to provide a balustrade arrangement that could utilise connector fittings between the cross rail and/or kick rail with the intermediate upright support posts, that will allow an ability for quick installation, structural integrity in the railed fence that has been created along with aesthetic appeal, wherein the various fittings and clamps required to interconnect the rails with the posts can be manufactured without expensive and difficult fabrication at cost effective pricing.

Further objects and advantages of the invention will become apparent from a complete reading of the following specification.

### SUMMARY OF THE INVENTION

Accordingly in one form of the invention there is provided a balustrade arrangement, said arrangement including:

a T-clamp, said T-clamp having a unitary blank sheet of metal pressed, folded and formed into a tubular shape member with a first open end and an opposing second open end wherein the tubular shape member and the first open end and the second open end are of a comparable dimension so as to allow a hand rail to be recessed therein the tubular shape member;
said tubular shaped member having opposing peripheral side edges running along the tubular shaped member wherein the opposing peripheral side edges terminate in a pair of separated tab extensions wherein said pair of separated tab extensions are substantially orthogonally orientated externally out from respective opposing peripheral side edges;
a cup adapted to enclose an upper end of an upright support post, said cup including a tab protrusion protruding from the cup, wherein the tab protrusion is adapted to nest therein between the separated pair of tab extensions from the opposing peripheral side edges of the tubular shaped member so that apertures defined within the pair of separated tab extensions and the tab protrusion protruding from the cup are alignable so as to allow a bolt to pass there through the apertures defined within the pair of separated tab extensions and the tab protrusion protruding from the cup; and such that a fastening of the bolt brings together the pair of separated tab extensions and the tab protrusion protruding from the cup thereby securable joining a rail recessed therein the tubular shape member with an upright support post to which the cup has enclosed an upper end of said upright support post.

In preference the tubular shaped member has a substantially curved profile between the open top and bottom ends of the tubular shaped member.

An advantage of such an arrangement is that one of the main balustrade fittings, that being the T-clamp, instead of being conventionally fabricated as it has been derived from a single unitary blank sheet of metal that has been pressed, folded and formed into the requisite tubular shape member with a unique curved smooth profile from end to end, provides not only a particularly aesthetic looking clamp, but also a versatile, easy to install connector that is able to connect the cross or hand rail to the support post.

As the T-clamp has not been fabricated but uniquely pressed, folded and formed from a blank sheet of metal, there are no unsightly edges, welded joins for the protruding tabs and so forth.

In preference each tab of the pair of separated tab extensions substantially orthogonally orientated externally out from the respective side edges of the tubular shape member include an inward depression or recess about the respective aperture.

In a further form of the invention there is provided a balustrade arrangement, said arrangement including a T-clamp, said T-clamp formed from two interconnecting curved halves adapted to be hingedly supported one to the other wherein the opposing peripheral edge to the interconnected edge of each curve shaped member includes a tab extension, such that when the two interconnecting curved halves are positionable about a tubular rail member each tab extension aligns to be substantially orthogonally orientated out from the established tubular shape of the forming of the T-clamp about the tubular rail member wherein a corresponding tab protruding out from a cup, wherein said cup is adapted to enclose an upper end of an upright support post is such that the tab protruding from the cup enclosing the upper end of the upright support tab is adapted to nest therein the physically separated pair of tabs protruding out from the peripheral rim of the hinged curved halves so that respective apertures defined within the tab extensions allow a bolt to pass therethrough so as to clamp the rail member to the upright support post.

Advantageously in this preferred embodiment of the invention the T-clamp again provides a unique way in which to provide adequate support between the cross rail/hand rail and the support post. By being able to interconnect the two curved halves through a hinging type arrangement allows the ability for quick installation wherein rather than having to run the clamp along the length of the cross rail to be placed in the position to engage the support post, the ability to be able to clamp the respective curved halves about the tubular rail member will provide a quick and simple way to then be able to connect the rail with the support post.

In a further form of the invention there is provided a balustrade arrangement, said arrangement including a T-clamp, said T-clamp including a curved plate adapted to circumferentially rest and be fastened in position along a tubular rail member, said curved rail plate including a central slot wherein a pair of spaced apart tabs are adapted to extend therefrom and be held in place wherein a corresponding tab protruding out from a cup, wherein said cup is adapted to enclose an upper end of an upright support post is such that the tab protruding from the cup enclosing the upper end of the upright support tab is adapted to nest therein the physically separated pair of tabs protruding out from the curved plate so that respective apertures defined within the tab extensions aligned so as to allow a bolt to pass therethrough wherein the fastening of the bolt clamps the rail to the upright support post.

Advantageously once again the main T-clamp can be formed without the requisite requirement of any substantial fabrication.

By having a two-piece T-clamp, firstly the main curved rail plate that is adapted to be rested and fastened upon the tubular member includes a unique slot the tab extensions can be passed therethrough and with shouldered extensions flanging out from the base of the tabs they can then be held in place up against the rail member in appropriate fixed orientation in order to engage the corresponding tab protruding out from the end cup which is enclosing the upper end of the upright support post.

In preference the rail plate is cut from a unitary blank sheet of metal with a central slot where it is pressed and formed into a substantially curved configuration to match the tubular shape of the rail member.

In still a further form of the invention there is a balustrade arrangement including an adjustable T-clamp, said T-clamp having a pair of unitary blank sheets of metal that have been pressed, folded and formed into a tubular shape that are adapted to come together about a tubular rail member to provide open ends so that a hand rail may be recessed therethrough, wherein each tubular shape member has a pair of physically separated tab extensions that are substantially orthogonally aligned out from the tubular shaped member, wherein the pair of tab extensions is also configured to substantially extend out over the adjacent or other unitary blank sheet of metal pressed, folded and formed into the corresponding tubular shaped member such that two or more pairs of tab extensions are adapted to protrude out from the clamp so as to engage two or more corresponding tabs wherein each tab extends from the end of a cup enclosing a separate rail and/or support post.

Advantageously with this kind of arrangement, as the T-clamp includes a plurality of tab extensions that are adapted to engage the tabs on separate end cups, means that installation around corners or curving between intermediate support posts and/or additional railings can all be completed without difficulty and as one pair of tab extensions will be laterally rotatable one with respect to the other, readjustment is possible between the respective rails and/or posts to achieve the adequate support, alignment and positioning.

In preference the arrangement further includes a base plate with a rounded slot having a raised internal slotted rim, wherein the raised internal slotted rim substantially matches the profile of a flanged end of an intermediate collar for supporting the upright support post to the base plate.

An advantage of such an arrangement is that the upright support post can be secured to the ground through the use of the base plate without any additional unsightly nuts and bolts that need to be hidden from view in order to maintain appropriate aesthetics.

By having the base plate include a main central circular slot with a raised slightly upwardly inclined open rim means the intermediate collar for supporting the upright support post to the base is fastened to the structure to which it is fixed upon.

In preference the arrangement includes a cylindrical intermediate collar wherein the cylindrical collar includes a flanged end at one end so that the cylindrical collar can be held within the base plate with the confines of the inclined raised rim.

As this intermediate collar can also be fixed in place against the base plate it can then provide the appropriate internal dimensions in order to fix a standard upright post on which the ends have not been flanged.

In preference the intermediate collar includes at a top open end a chamfered edge.

In preference the intermediate collar includes an internal rib protruding internally within the intermediate collar wherein said rib is adapted to preventing a post from rocking in place once it has been inserted into the intermediate collar.

In preference to the internal rib is configurable towards the base of the intermediate collar.

In preference the intermediate collar further includes one or more holes where locking screws can pass there through to fix the upright post in place within the intermediate collar, to which the intermediate collar is held in place by the structural engagement between the flanged end of the intermediate collar and the inclined raised rib about the circular slot of the base plate.

In preference the arrangement further includes a kick rail cup, wherein the kick rail cap is configured to be of comparable shape and dimensions for an end of a kick rail to be recessed therein.

In preference the kick rail cup includes a central slot wherein a tab extension is adapted to be passed there through, wherein said tab extension is riveted into a fastening engagement with said kick rail cup.

In preference the tab extension extending out from the kick rail cup is adapted to be inserted between the pair of separated tab extensions such that corresponding apertures on the tab extensions aligns so that a bolt can pass there through the respective apertures to be fastened.

Advantageously the T-clamp can also be configured to not only recess the hand rail but also as required be positioned up and down the longitudinal length of the upright support post so that it can provide structural support for the kick rail which has been recessed at one end and held in place by the kick rail cup where an inter-engagement between the kick rail cup is through the respect tab extensions.

In an alternative embodiment of the invention the kick rail cup inter-engages a hingedly connected two-piece T-clamp.

In order now to describe the invention in greater detail a series of preferred embodiments will be presented with the assistance of the following illustrations and accompanying text.

### BRIEF DESCRIPTION OF THE DRAWINGS

FIG. 1 is a perspective view of a preferred embodiment of the balustrade arrangement with respect to the T-clamp fitting.

FIG. 2 is a perspective view of the T-clamp fitting in FIG. 1 interconnected with an end cup adapted to recess and enclose therein the upper end of an upright support post.

FIG. 3 is a perspective view of a preferred embodiment of a rail plate clamp fitting.

FIG. 4 is a perspective view in relation to the preferred embodiment of the invention associated with an adjustable multiple fitting in a preferred embodiment of the invention.

FIG. 5 is a perspective view of a preferred embodiment of the invention in relation to the base support for the upright support post.

FIG. 6 shows a top perspective representation of a further preferred embodiment associated for the most part with an alternative T-clamp.

FIG. 7 illustrates a further preferred embodiment of the invention for the most part associated with the connecting of the balustrade arrangement kick rail to the upright support post.

### DETAILED DESCRIPTION OF THE DRAWINGS

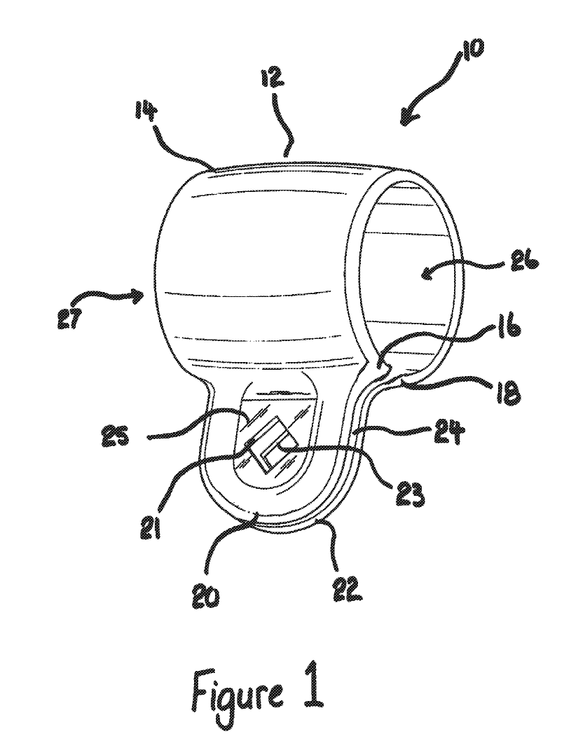

FIG. 1 shows a perspective view of a T-clamp shown generally as (10) in one preferred embodiment of the invention.

This T-clamp (10) forming part of the balustrade arrangement was formed from a cut blank sheet of metal that was pressed, folded and formed into the general tubular shaped member (12) as illustrated with the pair of open ends (26) and (27) at opposite ends of the tubular shaped member (12).

The respective openings (26) and (27) allow a tubular hand or cross rail to be recessed therein.

By being able to not rely on conventional fabrication means in order to manufacture the fitting, the pressing, folding and forming of the T-clamp into the tubular shape provides for an aesthetic appearance and as shown by way of the curve line (14) across the breadth of the T-clamp (10) as illustrated there is an aesthetic curved and smoothed profile (14).

At the respective ends (16) and (18) of the peripheral and/or circumferential tubular shaped member (12) extending out therefrom in a substantially orthogonal orientation from the peripheral terminating ends (16) and (18) of the tubular shaped member (12) is a pair of tab extensions (20) and (22) that are physically separated by space (24).

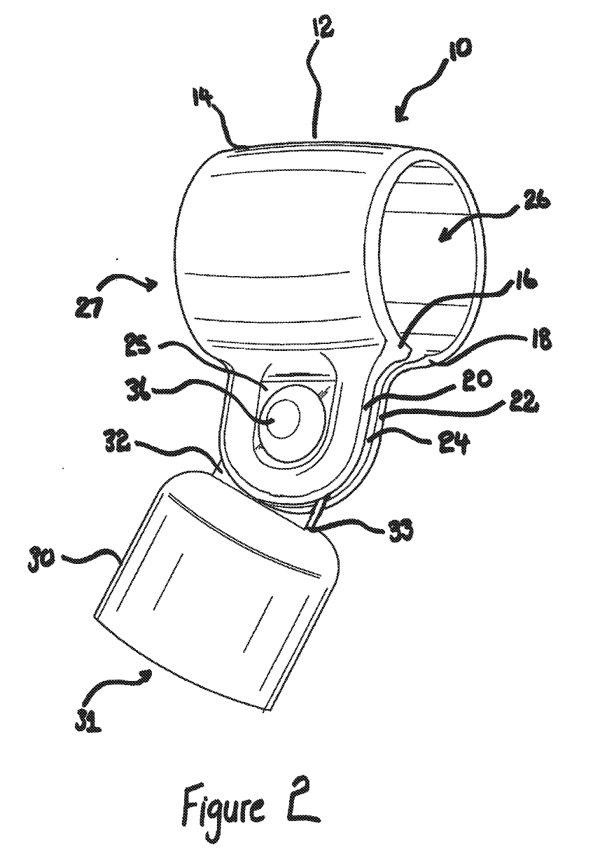

Each of the respective tab extensions (20) and (22) include an aperture which as explained in greater detail in relation to FIG. 2 will allow a fastening bolt to pass therethrough.

Each tab extension (20) and (22) includes a depressed recess shown by of (25) in FIG. 1 wherein the recessed nut of the fastening bolt can be snapped off as required.

FIG. 2 is an extension of FIG. 1 wherein the T-clamp (10) is interconnected with the end cup (30).

The end cup is of a configuration so that the opening (31) can enclose and recess therein an upper end of the upright support post (not shown).

The end cup (30) includes a slot (33) to which tab extension (32) extends there out from and in the preferred embodiment this tab has been riveted into place with the end cup (30).

Tab (32) of the end cup (30) is able to move into the space (24) between the pair of tab extensions (20) and (22) wherein the respective apertures (21), (23) as shown in FIG. 1 and the aperture (not shown) of the tab extension (32) of the end cup (30), so that the fastening bolt (36) can pass therethrough and be bolted accordingly so that the hand rail (not shown) and the upright support post (not shown) can be joined together.

While not shown in FIG. 2, the end cup can also include additional fastening features such as aperture holes for locking screws and so forth to be included so as to fix the enclosed upper end of the upright support post in place as required.

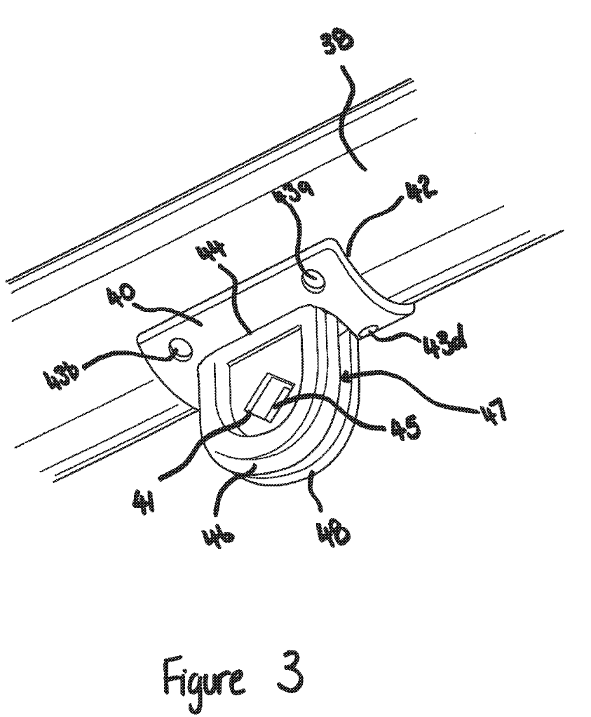

FIG. 3 illustrates an alternative preferred embodiment of the invention wherein there is a base rail plate (40) which has a curved profile (42) to match the tubular configuration of the rail post (38) which is fastenable, shown by way of aperture holes (43a), (43b) and (43d), to the hand rail (38).

The base rail plate includes a slot (44) to which the pair of tab extensions (46) and (48) can protrude as required out therefrom and be secured in place once the base rail plate (40) has been secured to the hand rail (38) or if need be in some configurations to upright support posts and so forth.

The tab extensions (46) and (48) provide the physical gap (47) there in between such as spacing 24 in FIGS. 1 and 2 so fittings such as the end cup (30) with its tab extension (32) can be inserted there in between the tab extensions (46) and (48) into the spacing for the alignment of the respective apertures (41) and (45) so that a fastening bolt (not shown) can then be secured there in place to connect and clamp the requisite componentry together within the balustrade arrangement.

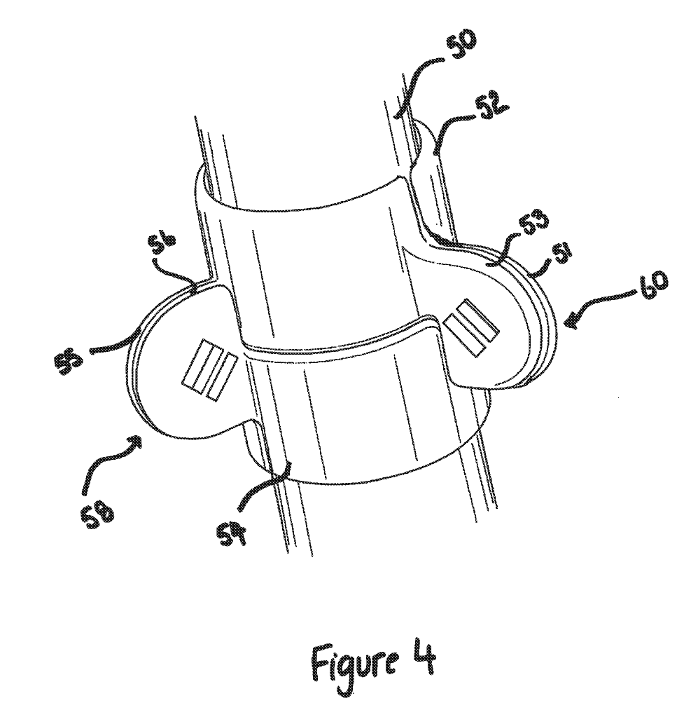

FIG. 4 shows a further preferred embodiment of a T-clamp arrangement which is made up essentially of two parts (52) and (54) which can be adjustably arranged around the tubular member (50).

Construction and manufacturing of the parts (52) and (54) remain faithful to that discussed in relation to FIGS. 1 and 2 but notably there is adjustability with respect to the separate T-clamp engagement point shown as (58) and (60) generally which each provide their requisite pair of tab extensions (55) and (56) in the case of T-clamp (58); and (51) and (53) in the case of T-clamp (60).

Advantageously this adjustable preferred embodiment shown in FIG. 4 will allow multiple engagements as there are more than one clamping position, which as shown in FIG. 4 includes (58) and (60). While the embodiment shown in FIG. 4 relates to a two-part assembly, as the person skilled in the art would appreciate, there is the opportunity of adding further segments such as (52) and (54) as required to introduce further clamping locations.

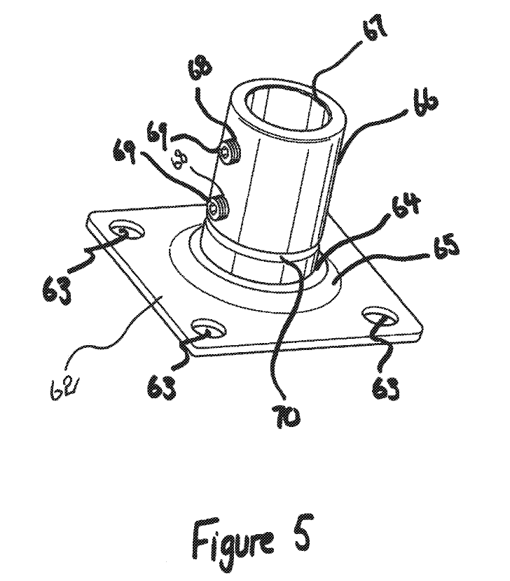

FIG. 5 represents a further preferred embodiment of the balustrade arrangement associated with the base support for the upright support post.

As illustrated in the preferred embodiment shown in FIG. 5 there is a base plate (62) which is fastenable to the requisite structure by fastening holes shown generally as (63).

This base plate (62) includes a raised circular rim (65) which provides for the slot (64) to which the cylindrical intermediate collar (66) can be secured thereto.

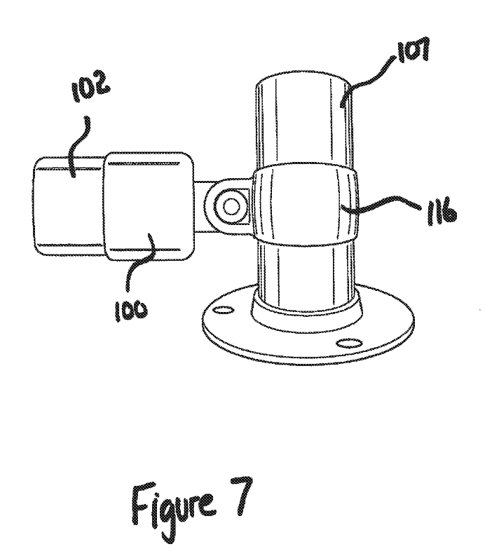

As best seen in FIG. 7, albeit it relates to an alternative embodiment of an intermediate collar for supporting the upright support posts, the base of the intermediate collar (66) is flanged with a similar configuration to the shouldered raised rim (65) of the base plate (62) such that the cylindrical intermediate collar (66) once the base plate (62) has been fastened in place then fixes the cylindrical intermediate collar (66) in place.

The cylindrical intermediate collar (66) includes a chamfered opening edge (67) which will allow the upright end post to pass there through and to be supported therein.

The internal protruding rib (70) as with the slightly chamfered or curved rim of the opening (67) of the cylindrical intermediate collar (66) allows the upright support post (not shown) to be prevented from rocking and so forth when in place.

Additional apertures (68) and locking screws (69) can also be included to fix the upright support post in place as required so it cannot be inadvertently lifted out from the cylindrical intermediate collar (66).

It is to be appreciated that in some preferred embodiments the intermediate collar may not be necessary in that the upright support posts can be specifically formed with the requisite flanged ends so as to be held in place directly to the base plate within the raised curved rim of the base plate.

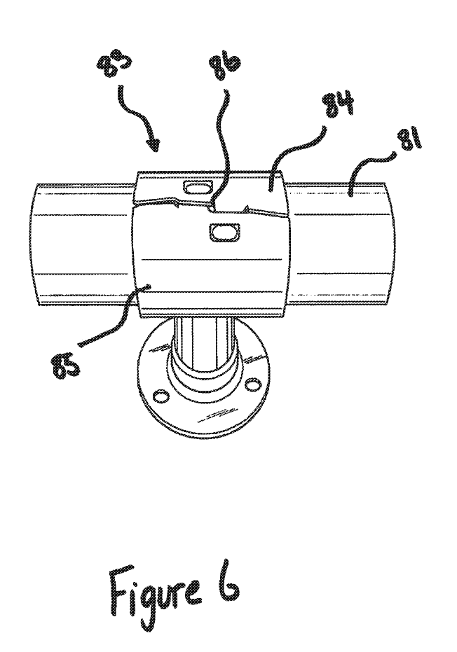

FIG. 6 illustrates an alternative embodiment of the invention, notably associated with the T-clamp (83) which includes two curved shaped halves (84) and (85) that are hingedly connected shown by way of number (86) so that they can be clamped around a rail or post (81).

FIG. 7 includes the kick rail (102) connected to the upright support post (107). The clamp (116) engages the end cup (100) which encloses the end of the kick rail (102). The end cup (100) may also include additional holes (not shown) wherein locking screws can also be used to fix the end of the kick rail in place as required.

Nonetheless the fundamental engagement between the end cup (100) and the T-clamp (116) shown are the same as those referred to other embodiments wherein the tab extension of the end cup is able to be inserted in between the pair of tab extensions from the T-clamp so that the requisite apertures align so that a fastening bolt can be passed therethrough to interconnect respective components.

1. A balustrade arrangement, said arrangement including:
a T-clamp, said T-clamp having a unitary blank sheet of metal pressed, folded and formed into a tubular shape member with a first open end and an opposing second open end wherein the tubular shape member and the first open end and the second open end are of a comparable dimension so as to allow a hand rail to be recessed therein the tubular shape member;
said tubular shaped member having opposing peripheral side edges running along the tubular shaped member wherein the opposing peripheral side edges terminate in a pair of separated tab extensions wherein said pair of separated tab extensions are substantially orthogonally orientated externally out from respective opposing peripheral side edges;
a cup adapted to enclose an upper end of an upright support post, said cup including a tab protrusion protruding from the cup, wherein the tab protrusion is adapted to nest therein between the separated pair of tab extensions from the opposing peripheral side edges of the tubular shaped member so that apertures defined within the pair of separated tab extensions and the tab protrusion protruding from the cup are alignable so as to allow a bolt to pass there through the apertures defined within the pair of separated tab extensions and the tab protrusion protruding from the cup; and
such that a fastening of the bolt brings together the pair of separated tab extensions and the tab protrusion protruding from the cup thereby securable joining a rail recessed therein the tubular shape member with an upright support post to which the cup has enclosed an upper end of said upright support post.

2. The balustrade arrangement of claim 1 wherein the tubular shaped member has a substantially curved profile between the first open end and the opposing second open end of the tubular shaped member.

3. The balustrade arrangement of claim 2 wherein each tab of the pair of separated tab extensions substantially orthogonally orientated externally out from the opposing peripheral side edges of the tubular shape member include an inward depression or recess about the defined aperture.

4. The balustrade arrangement of claim 1 furthering including a base plate with a rounded slot having a raised internal slotted rim, wherein the raised internal slotted rim substantially matches a profile of a flanged end of an intermediate collar for supporting the upright support post to the base plate.

5. The balustrade arrangement of claim 4 including a cylindrical intermediate collar wherein the cylindrical intermediate collar includes a flanged end so that the cylindrical intermediate collar is holdable within the base plate within confines of the raised internal slotted rim of the base plate.

6. The balustrade arrangement of claim 5 wherein the cylindrical intermediate collar includes at a top open end with a chamfered edge.

7. The balustrade arrangement of claim 6 wherein the cylindrical intermediate collar includes an internal rib protruding internally within the cylindrical intermediate collar wherein said internal rib is configured to prevent the upright support post from rocking once the upright support post has been inserted into the cylindrical intermediate collar.

8. The balustrade arrangement of claim 7 wherein the internal rib is configurable towards the base of the cylindrical intermediate collar.

9. The balustrade arrangement of claim 8 wherein the cylindrical intermediate collar further includes one or more holes where locking screws are passable there through to fix the upright post in place within the cylindrical intermediate collar.

10. The balustrade arrangement of claim 1 further including a kick rail cup, wherein the kick rail cup is configured to be of comparable shape and dimensions for an end of a kick rail to be recessed therein.

11. The balustrade arrangement of claim 10 wherein the kick rail cup includes a central slot wherein a kick rail cup tab extension is adapted to be passable there through said central slot of the kick rail cup, wherein said kick rail cup tab extension is fastenable with said kick rail cup when past through said central slot.

12. The balustrade arrangement of claim 11 wherein the kick rail cup tab extension is adapted to be inserted between the pair of separated tab extensions of the tubular shape member such that corresponding apertures defined within the kick rail cup tab extension and the pair of separated tab extensions of the tubular shape member are alignable so as to allow a bolt to pass there through the apertures defined within the kick rail cup tab extension and the pair of separated tab extensions of the tubular shape member; and
such that a fastening of the bolt brings together the kick rail cup tab extension and the pair of separated tab extensions of the tubular shape member thereby securable joining a kick rail with the upright support post.
